(19) United States
(12) Patent Application Publication
(10) Pub. No.: US 2007/0029138 A1
(43) Pub. Date: Feb. 8, 2007

(54) LADDER DOLLY

(76) Inventor: Garry Andrew HOWE, Indianola, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/161,536

(22) Filed: Aug. 8, 2005

(51) Int. Cl. E06C 7/42

(52) U.S. Cl. 182/107

(57) ABSTRACT

A ladder having a step frame and a support frame pivotably connected at one end. The step frame has a plurality of steps with a top step having handles formed in the sides of the top step. The support frame has a plurality of arcuate braces that are formed to receive a bucket of paint. Connected to the bottom end of the step frame are a pair of wheels that engage the ground surface when the ladder is tilted to a transport position. Also connected to the bottom end of the step frame is a support plate that extends outwardly between the support frame when the ladder is in a transport position.

### BACKGROUND OF THE INVENTION

This invention is directed toward a ladder dolly, and more specifically a ladder designed to transport paint and tools.

In the paint industry, particularly for larger commercial projects, a ladder, a number of large paint containers, and various tools such as brushes and scrapers are needed to perform the job. Transporting all these items to a job site can be cumbersome and time consuming. This is particularly the case in high rise facilities and the like.

Attempts have been made to solve these problems, but present devices are complicated and consist of many parts. Also, these devices do not retain items easily or as securely as desired. Therefore, there is a need in the art for a device that addresses these problems.

An objective of this invention is to provide a ladder that is capable of easily transporting items.

Another objective of this invention is to provide a transportable ladder made of fewer parts that is easy to assemble and manufacture.

A still further objective is to provide a transportable ladder that more securely retains materials.

These and other objectives will be apparent to those skilled in the art based on the following disclosure.

### SUMMARY OF THE INVENTION

A ladder having a step frame and a support frame pivotably connected at one end. The step frame has a plurality of steps with a top step having handles formed in the sides of the top step. The support frame has a plurality of arcuate braces that are formed to receive a bucket of paint. Connected to the bottom end of the step frame is a pair of wheels that engage the ground surface when the ladder is tilted to a transport position. Also connected to the bottom end of the step frame is a support plate that extends outwardly between the support frame when the ladder is in a transport position.

### BRIEF DESCRIPTION OF THE DRAWINGS

FIG. 1 is a perspective view of a ladder dolly;

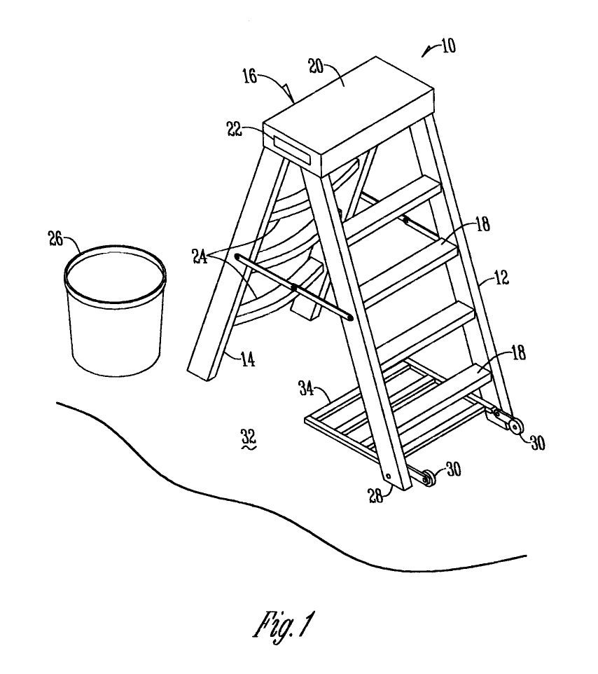

FIG. 2 is a side view of a ladder dolly in an operational position; and

FIG. 3 is a side view of a ladder dolly in a transport position.

### DETAILED DESCRIPTION OF THE PREFERRED EMBODIMENT

Referring to the Figures, a ladder dolly 10 has a step frame 12 and a support frame 14 that are pivotably connected at end 16. The step frame 12 has a plurality of steps or rungs 18 that extend between the frame 1 2. The top step 10 has a pair of handles 22 formed in sides of the top step 20. Alternatively, handles 22 are attached to the top step 20 in any conventional manner.

The support frame 14 has a plurality of braces 24. The braces 24 are arcuate and formed to fit and receive conventional buckets of paint 26.

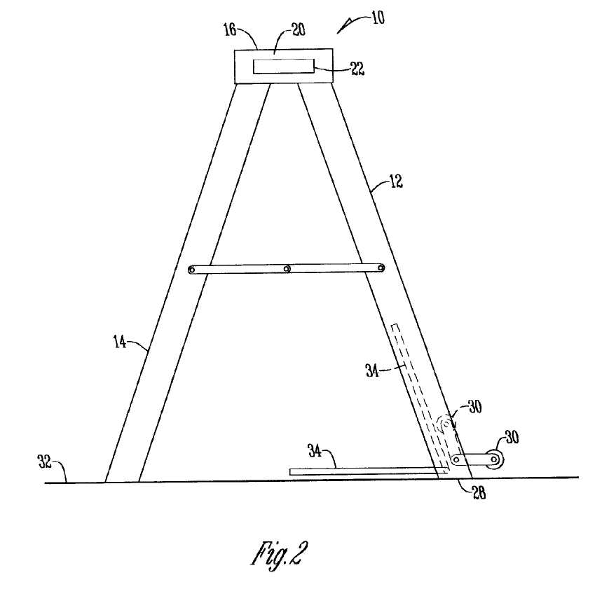

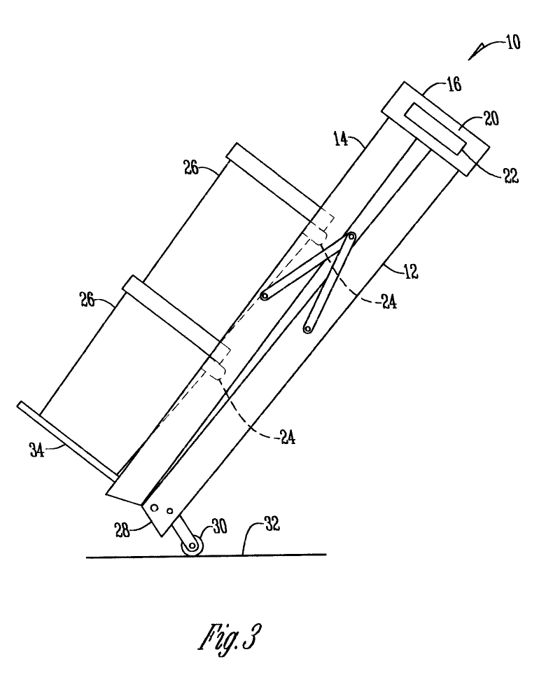

Attached to end 28 of the step frame 12 are a pair of wheels 30. The wheels are positioned such that they engage the ground surface 32 when the ladder 10 is tilted and in a transport position as shown in FIG. 3, and do not engage the ground surface when the ladder 10 is in an operational position as shown in FIG. 2. Alternatively, the wheels 30 are pivotably connected to end 28 of the step frame 12.

Also connected to end 28 of the step frame 12 is a support plate 34. Support plate 34 extends outwardly from the step frame 12 and between the support frame 14, when the ladder is in a transport position as shown in FIG. 3. In this manner, the support plate 34 provides support for the bottom of a paint bucket during transport. Alternatively, the support plate 34 is pivotably connected to the step frame. Additionally, the support plate 34 is fixedly or pivotably connected to the lower end of the support frame 14.

In operation, to transport materials, the step frame 12 and support frame 14 are pivoted about end 16 such that the frames are in general parallel alignment. In this position support plate 34 extends outwardly from step frame 12 between support frame 14. At least one paint bucket 26 containing paint or tools is placed on the support plate 34 such that a portion of the bucket 26 is received within one or more arcuate braces 24. By grasping handles 22 the ladder 12 is tilted such that wheels 30 engage the ground surface 32 as shown in FIGS. 3 where the ladder is transported across the ground surface.

To use the ladder 10 in a conventional manner, the paint buckets 26 are removed from the braces 24 and support plate 34, and the step frame 12 and support frame 14 are pivoted about end 16 so they are in a spaced relation as shown in FIG. 2.

From this disclosure a ladder dolly having few parts that easily retains and transports materials has been shown and at least all the stated objectives have been met.

What is claimed is:

1. A ladder dolly, comprising
a step frame having a plurality of rungs;
a support frame pivotably connected to the step frame at a first end, the step frame having a plurality of arcuate braces; and
a pair of wheels connected to the step frame at a second end.

2. The dolly of claim 1 further comprising a support plate connected to the step frame.

3. The dolly of claim 2 wherein the support plate is pivotably connected to the step frame.

4. The dolly of claim 1 wherein the wheels are pivotably connected to the step frame.

5. The dolly of claim 1 wherein a top rung of the step frame has handles formed in sides of the top rung.
